(19) United States
(12) Patent Application Publication
(10) Pub. No.: US 2025/0100182 A1
(43) Pub. Date: Mar. 27, 2025

(54) A Method for 3D Printing a Construction, a 3D Construction Printer System, and a Printing Unit for Use in a 3D Construction Printer System

(71) Applicant: COBOD INTERNATIONAL A/S, Nordhavn (DK)

(72) Inventor: Michael Holm, Nordhavn (DK)

(21) Appl. No.: 18/730,108

(22) PCT Filed: Jan. 18, 2023
(86) PCT No.: PCT/DK2023/050008

§ 371 Date: Jul. 18, 2024

(30) Foreign Application Priority Data
Jan. 18, 2022 (WO) PCT/DK2022/050007

(51) Int. Cl. B28B 1/00; B28C 5/12; B33Y 10/00; B33Y 30/00; B33Y 40/00

(52) U.S. Cl. CPC B28B 1/001; B28C 5/1253; B33Y 10/00; B33Y 30/00; B33Y 40/00

(57) ABSTRACT

A method for 3D printing a construction using a printing unit includes obtaining a precursor printing material, the precursor printing material including a binder, water, and sand; forming a flow of the precursor printing material towards the printing unit using a material pump; adding downstream of the material pump an amount of a first additive to the precursor printing material; optionally adding one or more additional additives; mixing the precursor printing material, the first additive and the optional one or more additional additives to form the printing material; and extruding the printing material via the printing head.

### CROSS-REFERENCE TO RELATED APPLICATIONS

This application is the national phase of, and claims priority to, International Application No. PCT/DK2023/050008, filed 18 Jan. 2023, which claims priority to International Patent Application No. PCT/DK2022/050007, filed 18 Jan. 2022.

### FIELD OF THE INVENTION

The invention relates to a method for 3D printing a construction, a 3D construction printing system, and a printing unit for use in a 3D construction printing system.

### BACKGROUND

3D printing of buildings and like constructions using non-homogeneous composite materials, such as concrete, as the printing material has been known for some time and is now moving into a more advanced stage of technological development, where the basic processes are being refined.

It is well known that when concrete and like non-homogeneous composite materials are transported over longer distances, for example being pumped through pipes or tubes, the quality of the material may be affected. This may for example result in segregation, where the aggregates separate from the cement paste of a concrete or becomes unevenly distributed. Furthermore, production stops may result in changes in the consistency of the concrete waiting to be used.

KR20190050509A and US2021/146573A1 each disclose a printing unit, which is provided with sensors allowing information about the amount and state of the printing material (concrete) found in the hopper to be communicated to a control unit and with additive outlets allowing the admixture of water, a fluidizing agent, a water reducing agent, and/or a stiffening agent.

This may allow fine-tuning of the printing material, e.g. in case the printing material is too stiff or too soft this may be compensated for.

It may, however, be difficult to secure an effective mixing of the elements added to the hopper. An ineffective mixing may result in variations in the material properties of the printing material, which may in turn result in imperfections and weaknesses in the printed construction. In 3D construction printer systems without a hopper in the printing unit, this problem is even more pronounced. It has been attempted to compensate for small variations in material properties by adding an additive directly in the printing head, but experiments have shown that it is very difficult to achieve a proper mixing with the printing material.

Furthermore, transporting the printing material to the printing unit may be challenging especially when constructing large constructions, such as multi-storage buildings.

Another problem, that occurs when building large constructions, is that the number of production stops, both planned and unplanned, is typically relatively high.

Handling a large 3D printing system filled with printing material during a production stop may be challenging. As an example, it may be highly problematic if the printing material starts to set inside the tubes and pumps used for transporting the printing material to a printing head.

### SUMMARY

According to one embodiment, a method for 3D printing a construction using a printing unit includes obtaining a precursor printing material, the precursor printing material including a binder, water, and sand; forming a flow of the precursor printing material towards the printing unit using a material pump; adding downstream of the material pump an amount of a first additive to the precursor printing material; optionally adding one or more additional additives; mixing the precursor printing material, the first additive and the optional one or more additional additives to form the printing material; and extruding the printing material via the printing head.

### BRIEF DESCRIPTION OF THE DRAWINGS

FIG. 1 is a flow chart showing an embodiment of a method for 3D printing a construction,

FIG. 2 is a schematic perspective view of an embodiment of a 3D construction printer system,

FIG. 3 is a schematic cross-sectional view of a first embodiment of a printing unit;

FIG. 4 is a schematic cross-sectional view of a second embodiment of a printing unit; and

FIG. 5 is a schematic cross-sectional view of a third embodiment of a printing unit,

FIG. 6 is a schematic cross-sectional view of a fourth embodiment of a printing unit,

FIG. 7 is a schematic cross-sectional view of a fifth embodiment of a printing unit,

FIG. 8 is a schematic cross-sectional view of a sixth embodiment of a printing unit,

FIG. 9 is an exploded perspective view of a parts of a seventh embodiment of a printing unit,

FIG. 10 is an exploded view of an additive tube, and

FIG. 11 is a perspective view of an additive tube.

### DETAILED DESCRIPTION

According to a first aspect the disclosure relates to a method for 3D printing a construction using a printing unit comprising a hopper and a printing head. The printing head is arranged below the hopper in the use state of the printing unit and configured to extrude a printing material via a nozzle opening. The method includes obtaining a precursor printing material, the precursor printing material comprising a binder, water, and sand; forming a flow of the precursor printing material towards the printing unit using a material pump; adding, downstream of the material pump, an amount of a first additive to the precursor printing material; optionally adding one or

SUBSTITUTE SPECIFICATION-CLEAN COPY more additional additives; mixing the precursor printing material, the first additive and the optional one or more additional additives to form the printing material; and extruding the printing material via the printing head. The first additive is added to the precursor printing material before the precursor printing material reaches the hopper.

Consequently, the printing material is formed close to the printing unit or in the printing unit by mixing a precursor printing material with the first additive close to the printing unit or in the printing unit, and it may thereby become simpler to build larger constructions.

As an example, the precursor printing material may have material properties facilitating pumping and potentially transport. Furthermore, the precursor printing material may have material properties facilitating cleaning of the material pump and other process equipment.

Another advantage of adding the first additive upstream of the hopper, i.e. before the precursor printing material enters the hopper, is that the movement of the precursor printing material travelling to the printing unit may contribute to the additive being at least partially mixed with the precursor printing material before entering the hopper.

Adding the first additive upstream of the hopper may further allow the additive to be admixed in dependence of the amount of precursor printing material being supplied to the printing unit. In this way the material entering the hopper is always of the same composition, and it is not necessary to rely on an estimate of the amount of printing material present in the hopper to calculate the actual composition.

The combination of improved mixing and a more precise control of the composition of the mixture provides the advantage that the printing unit may not only compensate for unintentional deviations from the intended properties of the printing material. It will be possible to actively alter the properties of the printing material to suit a specific purpose. Particularly it is envisaged that a relatively soft precursor printing material may be supplied to the printing unit and that the first additive is a viscosity modifying agent (VMA), i.e. the VMA may be added at the additive outlet to make the printing material stiffer. While 3D printing generally requires a relatively stiff material to be able to create the desired shapes, it is difficult to move a stiff material through pipes, which makes it difficult to supply the material to the printing head, and with increasing construction sizes, this has become a real problem. By allowing the use of a softer material, which is then made stiffer at the printing unit, less and/or cheaper equipment may be needed for moving the printing material. Still further, standard types of concrete, which can for example be bought from an external concrete producer, and/or which may be in use elsewhere on the construction site, may be used as precursor printing material, thus potentially eliminating the need for an on-site concrete production facility.

While reference is primarily made to concrete as an example of the printing material, i.e. the binder is cement, it is to be understood that the problems related to printing using concrete may also apply other types of printing material comprising a binder, water and sand. Examples of alternative binders are clay, lime, and polymers.

By “sand” is understood an inert granular material with a particle diameter of less than 4 mm, including geological material and recycled materials, such as glass. The particle size may be obtained by crushing and/or the material may be washed, sifted, or otherwise sorted to achieve a desired particle size distribution.

In addition to sand, the precursor printing material may comprise other aggregates, including for example rocks of a geological origin and recycled materials, such as crushed concrete. Furthermore, it may comprise fibres, such as steel fibres or natural fibres, and/or additives, such as air-entraining agents or plasticizers.

Binder, water, and sand may be mixed to form the precursor printing material at site e.g. at a construction site or at a remote location.

It is to be understood that the method may be used for constructing the walls of buildings but that it can also be used in the making of other constructions, which are not traditionally considered as buildings, such as foundations for buildings, bases for wind turbines, bridges, et cetera.

In some embodiments, at least a part of the mixing is done using a rotary element.

The rotary element may be arranged in the printing unit or any other unit of the system downstream of the material pump. A homogenous mixture may result by mixing immediately after adding the additive.

The rotary element may be arranged wholly or partially in the hopper of the printing unit. Thereby the printing material may be formed in the hopper by mixing the precursor printing material, the first additive, and the optional one or more additional additives.

Consequently, it may be ensured that only a small part of the system is provided with finished printing material. This may make handling of production stops, both planned and unplanned, easier.

Having the rotary element in the hopper may also, or alternatively, contribute to preventing a deterioration of the printing material, for example due to premature setting or segregation.

A rotary element in the hopper may comprise mixing arms and a motor for rotating the mixing arms in the hopper, thereby assisting in mixing the precursor printing material and the first additive as well as any additional additives.

A rotary element may be configured for advancing the printing material and generating a continuous flow of printing material through the printing head during printing, for example by using a rotating screw extending from the hopper into the printing head as the rotary element.

The printing unit may comprise more than one rotary element, for example a rotary element with mixing arms in the hopper and a rotating screw in the printing head.

In some embodiments the first additive is a viscosity modifying agent, VMA, configured to increase the viscosity of the precursor printing material, or an accelerator configured to accelerate setting and/or hardening of the printing material.

By using a precursor printing material with a lower viscosity than the printing material, it becomes easier to pump the printing material. This allows the use of simpler pumping equipment and/or construction of larger constructions. Furthermore, the lower viscosity of the precursor printing material may make cleaning of the material pump and other process equipment easier and facilitate transportation, for example in a mixer truck.

The precursor printing material may be deliberately chosen to have a viscosity being too low to use the precursor printing material as a printing material.

Using a precursor printing material with a slower setting and/or hardening than desired for the printing material reduces the risk of the material setting or hardening inside the system, which is particularly advantageous in case of production stops, and may further facilitate cleaning.

Adding the first additive closer to the printing unit may also be advantageous with respect to the additive consumption and may allow the use of additives, which would otherwise not be suitable, such as for example an accelerator causing a quick setting and/or hardening.

If two additive outlets are arranged at a distance from each other in the material transport direction, two additives may be added at different times, one before the other. This may for example be advantageous if one additive has a higher viscosity than the other or if there is a risk that one additive may disturb the effect of the other if they are added together. It may also be advantageous to provide three or more outlets.

This may for example allow different outlets to be used for different additives at different times depending on the printing material properties required.

It may be advantageous to add an accelerator as the first additive and to subsequently add a VMA in the form of a stiffener.

In some embodiments, the volume permille of the first additive in the printing material is at least 0.2%, at least 0.5% or at least 1.2%.

Consequently, by adding the first additive the properties of the printing material may differ significantly from the precursor printing material, e.g. the viscosity of the printing material may be significantly higher than the viscosity of the precursor printing material.

The volume permille of the first additive in the printing material is given by the equation below:

v%_{fa}=vₚₘ/v_{fa}·1000%
where v%_{fa} is the volume permille of the first additive in the printing material, vₚₘ is the volume of printing material extruded within a period of time, and v_{fa} is the volume of the first additive in the volume of printing material extruded within the period of time.

In some embodiments, the volume permille of the first additive in the printing material is less than 10%, less than 5% or less than 2.5%.

In some embodiments the construction is constructed at a construction site, whereas binder, water, and sand are mixed away from the construction side to form the precursor printing material and by one or more transport vehicles transported to the construction site.

Consequently, the construction costs may be lowered as more process steps may be performed offsite e.g. at a central production facility specialized in producing precursor printing material.

The transport vehicle may be any transport vehicle such as a truck or a ship.

One or more additives may be added using one or more additive pumps.

In some embodiments, the material pump generates a pulsating flow of the precursor printing material towards the hopper, and the first additive is added to the precursor printing material before the precursor printing material reaches the hopper.

If the material pump generates a pulsating flow of the precursor printing material, the additive pump may generate a pulsating flow of the first additive synchronized with the pulsating flow of the precursor printing material.

Consequently, by synchronizing the material pump and the additive pump an efficient mixing between the precursor printing material and the first additive may be achieved even in a hopper, where there is a continuous flow of printing material towards printing head, i.e. where material is being consumed continuously.

The material pump that pumps the precursor printing material may be any pump configured to generate a pulsating flow. As an example, the material pump may be a piston pump.

The material pump and the additive pump may be synchronized so that the ratio between the volumetric flow of these pumps at any given point in time is substantially constant.

According to a second aspect, the disclosure relates to a 3D construction printing system configured for printing using a printing material. The 3D construction printing system includes a printing unit, a gantry system, a material pump, a flexible tube and an additive system. The printing unit has a hopper, a printing head, and a rotary element. The additive system includes a control mechanism, an additive outlet, and a control unit. The gantry system is configured for moving the printing unit in a three-dimensional space. The material pump is configured to receive a precursor printing material comprising binder, water, and sand and pump the precursor printing material towards the printing unit via the flexible tube forming a flow of the precursor printing material in a material transport direction. The hopper is arranged downstream of the material pump in the material transport direction and upstream of the printing head. The control unit is operationally connected to the control mechanism of the additive system for controlling an amount of additive added to the precursor printing material. The additive outlet of the additive system is located upstream of the hopper in the material transport direction and provides a connection for fluid between the control mechanism and the flow of the precursor printing material downstream of the material pump. The control unit is configured to control the control mechanism to form a flow of the first additive to the flow of precursor printing material, whereby a flow of printing material is formed for extruding via a nozzle opening of the printing head.

By mixing a precursor printing material with the first additive close to the printing unit or in the printing unit, it may become simpler to build larger constructions as described above with reference to the first aspect of the invention. To avoid undue repetition, some embodiments and advantages of the invention are only described with reference to one aspect of the invention. It is to be understood that such embodiments and advantages may also apply to the other aspects.

In some embodiments, the hopper has a rotary element configured to advance the printing material and generate a continuous flow of printing material towards the printing head during printing.

The control mechanism of the additive system may be a control valve and/or an additive pump, e.g. a high precision pump capable of precisely dosing the first additive.

In some embodiments, an additive outlet for an additional additive is arranged in the printing unit.

In some embodiments, the system comprises an additive container, the additive container comprising an outlet fluidly connected to the control mechanism of the additive system, wherein the additive container contains an amount of the first additive.

In some embodiments, the additive container is a replaceable container e.g. a container that can be replaced with a new additive container once depleted.

In some embodiments, the additive container is a single use disposable container.

In some embodiments, the additive container contains, when full, at least 0.25 litres of the first additive, at least 0.5 litres of the first additive, or at least 2 litres of the first additive.

In some embodiments, the control unit of the additive system is configured to control the control mechanism to add an amount of additive to the flow of precursor printing material so that the volume permille of the first additive in the printing material is at least 0.2%, at least 0.5% or at least 1.2%.

In some embodiments, the control unit of the additive system is configured to control the control mechanism to add an amount of additive to the flow of precursor printing material so that the volume permille of the first additive in the printing material is less than 10%, less than 5%, or less than 2.5%.

In some embodiments, the system further comprises at least one additive pump for supplying additive.

In some embodiments, the material pump is configured to generate a pulsating flow of the precursor printing material towards the hopper, and the additive 5 system is configured to add the first additive to the precursor printing material before the precursor printing material reaches the hopper, possibly by the additive pump being configured to generate a pulsating flow of the first additive synchronized with the pulsating flow of the precursor printing material.

Consequently, by synchronizing the material pump and the additive pump, an effective mixing between the precursor printing material and the first additive may be achieved even in the hopper, even if there is a continuous flow of printing material towards the printing head.

The material pump that pumps the precursor printing material may be any pump configured to generate a pulsating flow. As an example, the material pump may be a piston pump.

The material pump and the additive pump may be synchronized so that the ratio between the volumetric flow of these pumps at any given point in time is substantially constant.

The system may be configured to mix the precursor printing material and the first additive in the hopper, by the hopper being provided with a rotary element comprising a motor and mixing arms for assisting in mixing the precursor printing material and the first additive.

In one embodiment, the additive system comprises an adaptor arranged between the material pump and the hopper in continuation of the flexible tube so that the flow of the precursor printing material passes through the adaptor, and where at least one additive outlet is provided in the adaptor. This allows adaptation of an existing 3D construction printing system without an additive system or adaption to another use of a 3D construction printing system.

The adaptor may comprise one or more side branches, such as pipe stubs, extending from a main section of the adaptor, said side branches being configured for connection to an additive storage unit or for receiving an additive tube having an additive outlet.

In one embodiment, at least one additive tube with an additive outlet extends into the adaptor so that the additive outlet is located at a centre line of the adaptor, said centre line extending in parallel with the material transport direction. As will be described in further detail below, this may contribute to achieving a well-mixed printing material.

In one embodiment, the additive storage is arranged above the additive outlet in the use state, and a valve or an additive pump is provided to control an amount of additive added.

In one embodiment, a material inlet valve is located upstream of an additive outlet in the material transport direction.

According to a third aspect the disclosure relates to a printing unit for use in a 3D construction printing system and configured for printing using a printing material including a precursor printing material and a first additive. The precursor printing material includes a binder, water, and sand. The printing unit has a material inlet; a hopper configured for accommodating a quantity of the printing material; a printing head configured for extruding the printing material, the printing head being arranged downstream of the hopper in a material transport direction; a rotary element configured for moving the printing material in the material transport direction from the hopper to the printing head; and an additive outlet, wherein the additive outlet is located upstream of the hopper in the material transport direction.

Providing the additive outlet upstream of the hopper means that the additive can be admixed in dependence of the amount of precursor printing material being supplied to the printing unit. In this way the material entering the hopper can have a constant composition, and it is not necessary to rely on an estimate of the amount of printing material present in the hopper to calculate the actual composition.

By providing the additive outlet upstream of the material hopper, i.e. before the precursor printing material enters the hopper, the movement of the precursor printing material travelling to the material inlet may contribute to the additive being at least partially mixed with the precursor printing material before entering the hopper.

Particularly in large printing units designed for receiving and extruding large quantities of printing material per time unit, it may be advantageous that the printing unit further comprises a rotary element arranged in the hopper.

In one embodiment, the material inlet comprises at least one inlet pipe projecting from a main body of the hopper, and an additive outlet is provided in the material inlet pipe.

If more than one additive outlet is provided on the material inlet, they may be arranged at a distance from each other in the material transport direction to allow different additives to be added at different times as described above. A similar effect may be achieved by adding the first additive in or at the inlet pipe and another directly in the hopper.

In one embodiment, the additive outlet is provided on a side of the material inlet pipe, which side will be oriented upwards in the use state of the printing unit. In this way gravity may assist the admixture of the additive. This may also apply to an adaptor as described above.

An additional or alternative way of facilitating admixture is to have an additive outlet formed in an additive tube, the additive tube projecting into material inlet pipe.

Consequently, the additive may be added to a central part of the flow of precursor printing material. This may result in a faster and more efficient mixing of the additive and the precursor printing material.

An additive outlet may be located at a centre line of the material inlet pipe, said centre line extending in parallel with the material transport direction. This may be achieved by at least the distal section of the additive tube having the additive outlet extending substantially in parallel to the centre line of the material inlet pipe. Experiments have shown than when pumping concrete, there may be a higher concentration of aggregates at the centre line of the pipe transporting the concrete. Arranging the additive outlet at the centre line may help to reduce this effect, thereby contributing to achieving a well-mixed printing material.

It may also be advantageous to have an additive outlet located between the centre line and inner side of the material inlet pipe, for example half-way between the centre line and inner side of the material inlet pipe. This may reduce the resistance to the material flow in the material inlet pipe and/or reduce the risk of the material inlet pipe becoming clogged. This also applies to an adaptor.

Which embodiment and position of an additive outlet is better will depend on factors such as the diameter on the material inlet pipe, the viscosity of the additive, the viscosity of the precursor printing material, and if the additive is water-soluble, and it may be determined by experiments.

In one embodiment the printing unit further comprises an additive storage unit connected to an additive outlet. The additive storage may be arranged above the additive outlet in the use state of the printing unit so that the additive may be supplied under the influence of gravity, in which case a valve can be provided to allow control of the amount of additive added. Alternatively, an additive pump may be provided to pump the additive to the additive outlet.

In one embodiment, the printing unit further comprises a material inlet valve located upstream of the additive outlet in the material transport direction. This provides precise control over the amount of precursor printing material entering through the material inlet and thus entails that even the very first precursor printing material entering the printing head at the beginning of the printing process or after a production stop will have the intended well-defined composition. Furthermore, the valve will allow a quick and precise shut-off of the precursor printing material supply in case of production stops and at the end of a printing process, which may lead to reduced waste of precursor printing material and/or cleaning of the hopper and the rotary element, if any.

The different aspects of the invention can be implemented in different ways including a method for 3D printing a construction, a 3D construction printing system and a printing unit for use in a 3D construction printing system described above and in the following, each yielding one or more of the benefits and advantages described in connection with at least one of the aspects described above, and each having one or more preferred embodiments corresponding to the preferred embodiments described in connection with at least one of the aspects described above and/or disclosed in the dependent claims. Furthermore, it will be appreciated that embodiments described in connection with one of the aspects described herein may equally be applied to the other aspects.

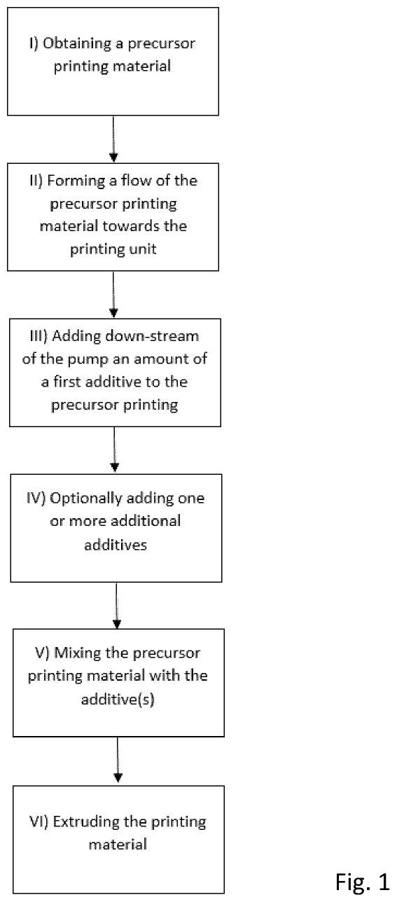

Referring now to FIG. 1, a flow diagram an embodiment of a method for 3D printing a construction is shown.

In step I) a precursor printing material is obtained. It may be made in an on-site mixing unit or supplied from an external manufacturing site. The precursor printing material may for example be concrete or another non-homogeneous composite material comprising a binder, water, and sand.

In step II) a flow of the precursor printing material towards the printing unit is formed using a material pump. The flow may be continuous or pulsating, for example if using a piston pump, but the flow rate should be well-defined and precisely controlled.

In step III) an amount of a first additive is added to the precursor printing material. The admixture of the additive takes place downstream of the material pump and upstream of a hopper of the printing unit in the material transport direction, i.e. between the material pump and the printing unit. The first additive may be added using an additive pump, and this pump may be synchronized with the material pump used for forming the flow of the precursor printing material so that the ratio between the volumetric flow of the material pump and the additive pump at any given point in time is substantially constant. In other words, if desired, the amount of additive to a given amount of precursor printing material is always the same.

Step IV) is optional and consists in the admixture of one or more further additives. An example of such an additive is an air-entraining agent.

In step V) the precursor printing material is mixed with the additive(s) added in steps III) and IV), thereby forming the printing material. At least a part of the mixing is done using a rotary element arranged in the printing unit, using for example a rotary element arranged in the hopper.

In step VI) the printing material is extruded via the printing head, which comprises a nozzle giving the extruded material a desired shape. The speed of extrusion in controlled by the operation of the rotary element.

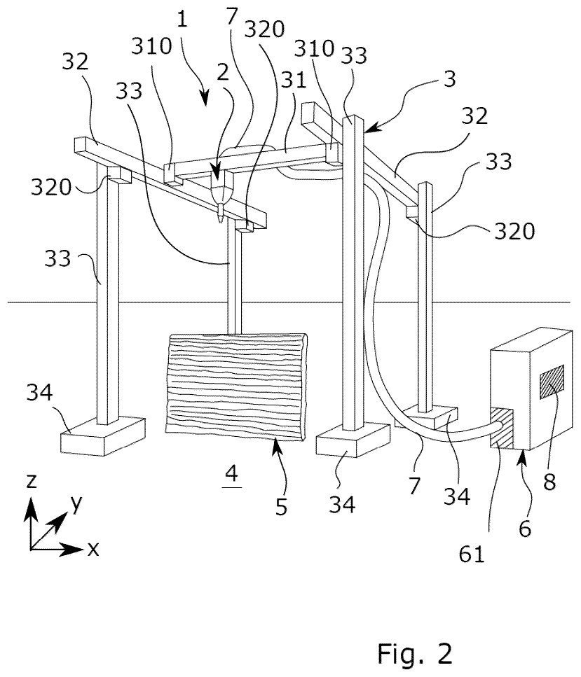

Referring now to FIG. 2, a 3D construction printer system 1 is shown. It

comprises a printing unit 2 mounting on a gantry system 3 configured for moving the printing unit in a three-dimensional space defined by axes X, Y, and Z. The printing unit 2 is mounted to be moveable along a first horizontal beam 31 in a horizontal direction along the X-axis, the first horizontal beam is mounted to be moveable along a set of second horizontal beams 32 in a horizontal direction along the Y-axis, and the second set of horizontal beams are mounted to be moveable along four uprights 33 in a vertical direction along the Z-axis. The position and extend of the four uprights 33 thus delimit the space in which the printing unit 2 can move. The movement of the beams 31, 32 is here achieved by the use of motors built into attachments blocks 310, 320 and the printing unit 2 is moved by a chain drive (not visible) driven by a motor built into attachments blocks of the first horizontal beam 310.

Each of the four uprights 33 of the gantry system 3 rest on a foundation 34 provided on the surface 4 on which a construction is to be printed, and a first wall 5 of a building has been printed. The surface 4 may for example be a ground surface, a foundation, or an upper surface of an existing construction.

Next to the gantry system 3 a precursor printing material supply facility 6 is shown, and a tubing system 7 connects the precursor printing material supply facility to the printing unit 2, serving as a precursor printing material supply line.

The precursor printing material supply facility 6 may comprise a rotary element and/or a buffer unit for receiving precursor printing material produced elsewhere. The precursor printing material may for example be concrete and may be made in the precursor printing material supply facility or supplied from an external manufacturing site. It is also possible to modify a material supplied from an external manufacturing site in the precursor printing material supply facility, for example by admixing one or more additives, aggregates, or fibres.

A material pump 61 is used for pushing the precursor printing material from the precursor printing material supply facility 6 through the tubing system 7 to the printing unit. In the embodiment shown, the material pump is integrated in the precursor printing material supply facility 6, but it could also be a separate unit. Likewise, it is to be understood that the material pump 61 could be replaced by or supplemented with a material pump arranged at or on the gantry system 3, and that such a material pump might be a suction pump. At present it is considered advantageous to use a piston pump, which is well suited for moving high viscosity material. This applies regardless of how other parts of the 3D construction printer system are embodied.

The tubing system 7 is here composed of flexible tubes allowing the tubing system to follow the movement of the gantry system 3 and the printing unit so that a continuous and reliable supply of precursor printing material is ensured. The tubing system may also comprise pipes.

One or more additive supply lines (not shown) may be integrated in the tubing system 7.

In the embodiment shown, a control unit 8 for controlling the supply of precursor printing material to the printing unit 2 is built into the precursor printing material supply facility. The control unit 8 could alternatively be located elsewhere, including on or at the printing unit 2 or on or at the gantry system 3.

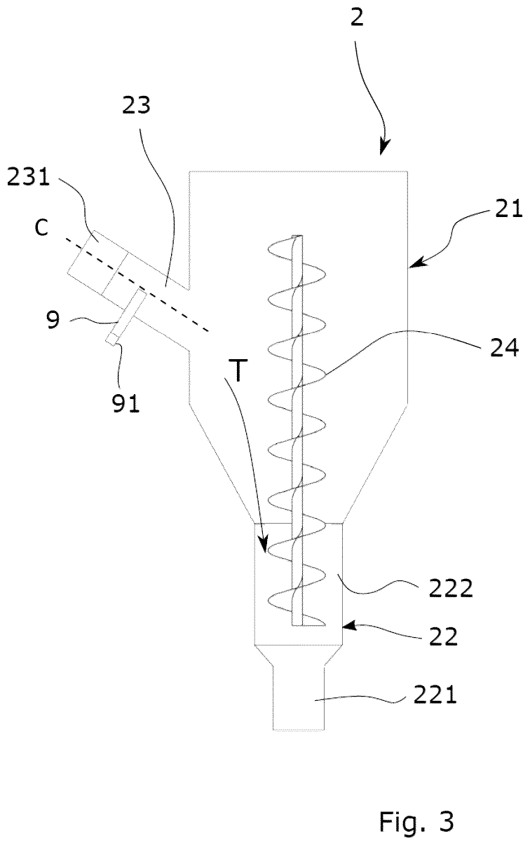

An embodiment of the printing unit 2 is shown in FIG. 3. It comprises a hopper 21 and a printing head 22, which is arranged below the hopper in the use state of the printing unit. A material inlet pipe 23 extends from a side wall of the hopper 21, and a rotary element in the form of a rotating screw 24 extends from the hopper into the printing head. When printing material (not shown) has been supplied to the hopper, the screw serves to carry it into the printing head. The hopper is thus arranged before the printing head in a material transport direction T.

The screw 24 may also be used to agitate printing material contained in the hopper, so that it does not set prematurely, for example during a production stop.

The printing head 22 comprises a nozzle 221, through which the printing material is extruded, and a barrel 222 configured for guiding the printing material to the nozzle. As such printing heads are well-known to the skilled person, it will not be described in further detail here.

An additive outlet in the form of additive tube 9 projecting into material inlet pipe 23 allows an additive, such as a viscosity modifying agent, to be added to the precursor printing material before it enters the hopper 21. The upstream end of the material inlet pipe 23 seen in the material transport direction T may thus be said to constitute a precursor printing material inlet and the downstream end of the material inlet pipe 23 may thus be said to constitute a printing material outlet.

In this embodiment the additive tube projects to the centre line C of the material inlet pipe, whereby the additive is added to the centre of the flow of the precursor printing material, but it is to be understood that in other embodiments the additive tube does not project as far into the material inlet pipe.

In the embodiment shown in FIG. 3, both the material inlet pipe 23 and the additive tube 9 are provide with pinch valves 231, 91, which can be used for stopping the flow of precursor printing material and additive, respectively. This allows for a quick and well-controlled stop of the supply in case of a production stop.

The flow of the precursor printing material through the material inlet pipe 23 into the hopper 21 and the rotation of the screw 24 result in the additive being mixed with the precursor printing material, thereby creating the printing material for use in the printing head.

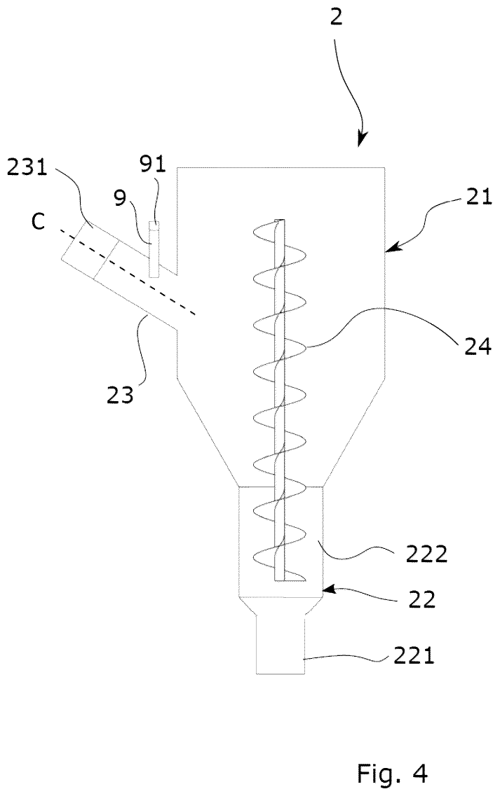

Turning now to the second embodiment of the printing unit shown in FIG. 4, the same reference numbers will be used as in FIG. 3, and only the differences between the two embodiments will be described. These reference numbers will also be used in the remaining figures for elements having similar function.

In FIG. 4 the additive tube 9 is arranged on the side of the material inlet pipe 23 facing upwards in the use state of the printing unit 2 and the additive tube 9 is substantially vertical, whereas the additive tube 9 in FIG. 3 extends substantially perpendicular to the centre line C of the material inlet pipe. This arrangement of the additive tube 9 may facilitate supply of the additive, as gravity may help it through the additive tube. Furthermore, the angle between the additive tube 9 and the material inlet pipe 23 may result in an improved mixing of the additive with the precursor printing material.

The additive tube 9 is here shown with a straight end, but it is to be understood that may also be inclined so that one side of the pipe extends further into the material inlet pipe than the other as in FIG. 8. It is further to be understood that the additive tube 9 does not need to project into the material inlet pipe, and that an additive outlet (not shown) in the form of a simple opening in the material inlet pipe may replace the additive tube 9.

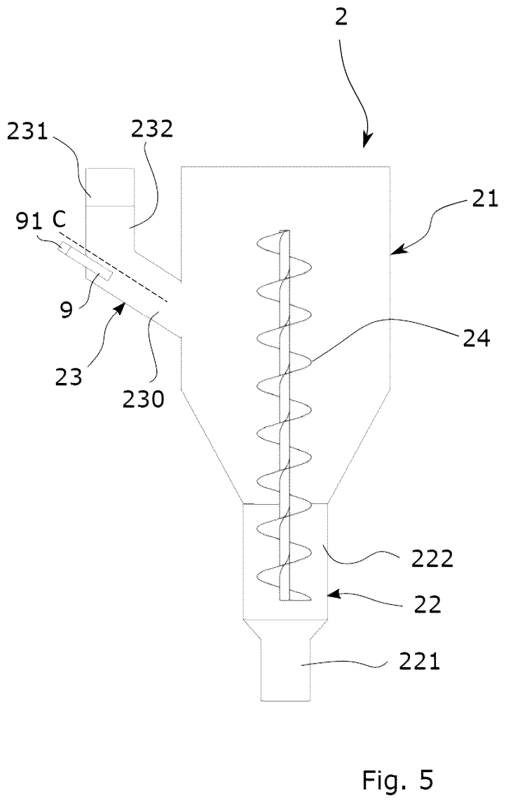

Turning now to the third embodiment of the printing unit shown in FIG. 5, the same reference numbers will be used as in FIGS. 3 and 4, and only the differences between the embodiments will be described.

In this embodiment the material inlet pipe 23 comprises a bend and in addition to the first section 230 extending from the side wall of the hopper 21 it has a second section 232 extending upwards substantially in parallel with the side wall of the hopper 21. This allows for the additive tube 9 to project into the material inlet pipe 23 at the bend, extending along the centre line C of the first section 230 of the material inlet pipe 23. This means that additive entering the material inlet pipe flows in the same direction as the precursor printing material, which may facilitate mixing.

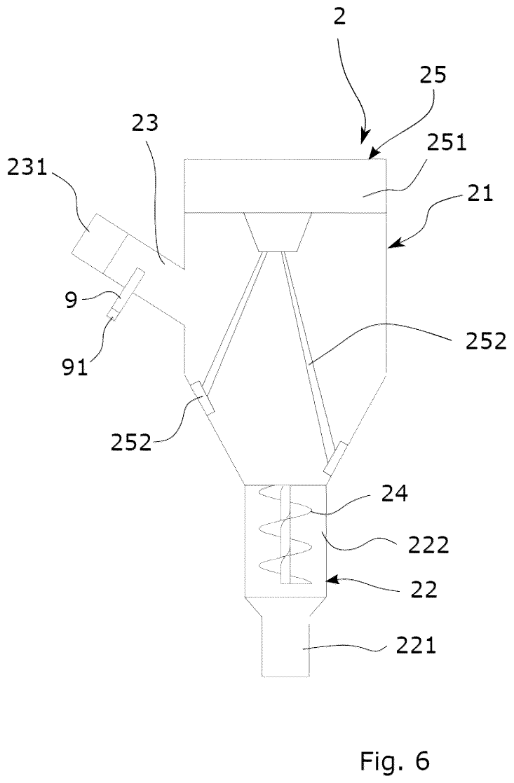

Turning now to the fourth embodiment of the printing unit shown in FIG. 6, the same reference numbers will be used as in FIGS. 3-5, and only the differences between the embodiments will be described.

In this embodiment the hopper 21 is provided with a rotary element 25 comprising a motor 251 and two mixer arms 252 configured for turning inside the hopper and constituting a rotary element. The screw 24 is here relatively short, extending only in the barrel 222 of the printing head 22. This embodiment is presently preferred as the movement of the screw may not be enough to achieve a satisfactory mixing of the precursor printing material with the additive.

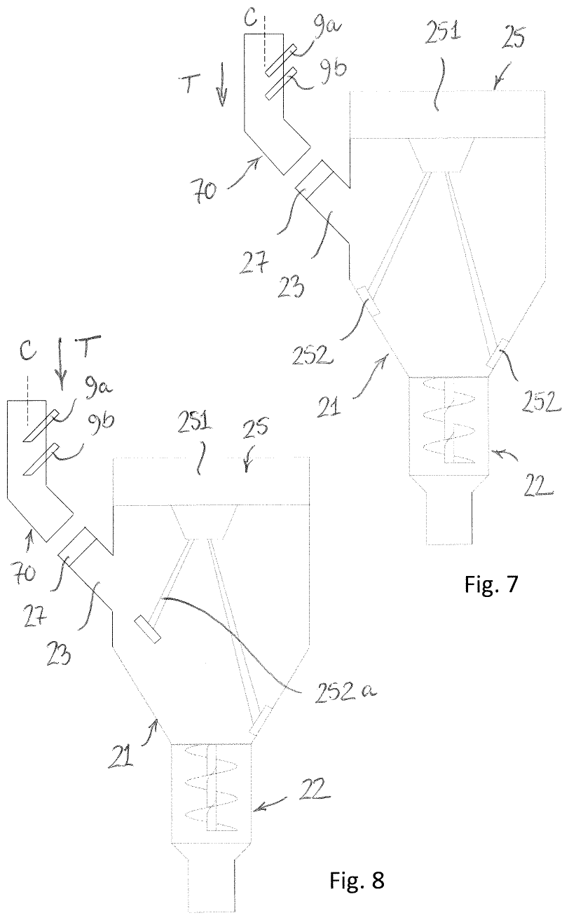

In the embodiments in FIGS. 3-6 the material inlet pipe 23 extends at an angle of approximately 30 degrees in relation to horizontal in the use state of the printing unit, but it is to be understood that other angles are possible. Angles of 20-50 degrees in relation to vertical in the use state of the printing unit are presently considered advantageous, and a further printing unit with an angle of 45 degrees in shown in FIG. 7. This embodiment further differs from the one in FIG. 6 in that it comprises two additive tubes 9a, 9b provided on an adaptor 70 separate from the material inlet pipe 23. The material inlet pipe 23 of the hopper 21 is here provided with a connector 27, such as a thread, for interconnection with the adaptor 70 or with a tubing system 7.

In FIG. 7 each of the two additive tubes 9a, 9b extends at an angle of 45 degrees to the material transport direction T in the substantially the same way as in FIG. 4 and to the centre line C of the pipe unit as also described above.

The two separate additive tubes 9a, 9b provided at a distance from each other in the material transport direction T allow one additive to be added before another. This may for example be advantageous if one additive has a higher viscosity than the other or if there is a risk that one additive may disturb the effect of the other if they are added together. While only two additive tubes are shown, it is to be understood that there may be more.

The embodiment shown in FIG. 8 corresponds to the one in FIG. 7, except for the design of the rotary element 25 and for the design of the additive tubes 9a, 9b.

Here one mixing arm 252a is shorter than in FIG. 8 to operate higher in the hopper 21, hereby potentially contributing to reducing the risk of the formation of dead zones, where the printing material is not worked properly. A similar effect may be achieved by providing additional arms or by using an alternative mixer type.

The additive tubes 9a, 9b here have bevelled ends so that the additive outlets are facing downwards, in the material flow direction T. This reduces the risk of the additive tubes being blocked by concrete and may facilitate admixture of additives.

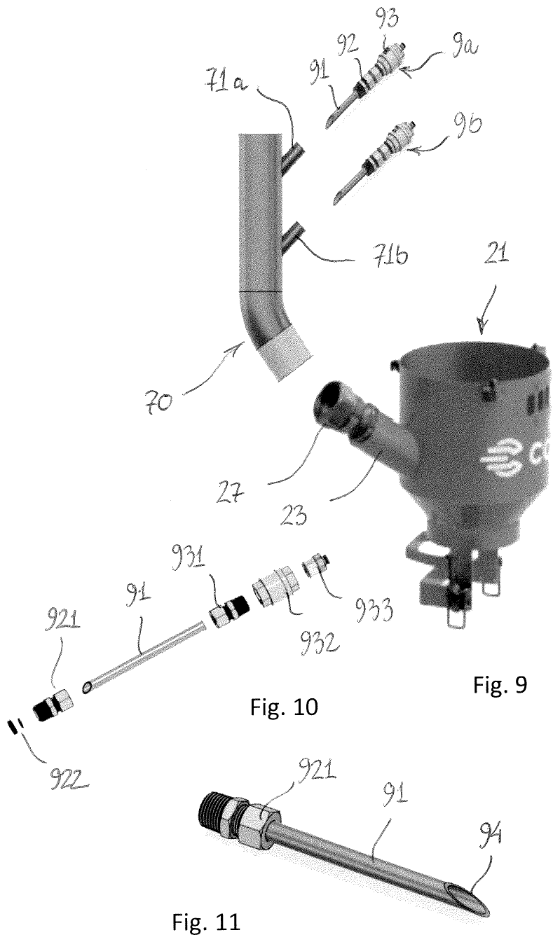

A further embodiment of a printing unit of the same overall structure as in FIG. 3-8, shown without the printing head, is seen in FIG. 9. Here a separate adaptor 70 with two pipe stubs 71a, 71b is provided for receiving two additive tubes 9a, 9b. Each additive tube here consists of a pipe section 91 and set of connector fittings 92, 93 for attachment to the pipe stubs and to an additive supply line (not shown), respectively.

It is to be understood that even though those of the shown embodiments comprising two additive tubes all include an adaptor, two or more additive tubes may also be provided on the material inlet pipes 23 in FIG. 3-6, and that the provision of two or more outlet opening at a distance from each other may be advantageous even in embodiments without additive tubes.

The adaptors 70 shown in the drawing all have a bend, but it is to be understood that an adaptor may be straight or have more than one bend. Likewise, the dimensions of the adaptor may vary.

An exploded view of the additive tubes 9a, 9b shown in FIG. 9 is seen in FIG. 10. At one end of the pipe section 91, connector fitting 92 for attachment to the pipe stub 71a, 71b is seen to comprise a threaded fitting part 921 and gasket members 922, and at the other end the connector fitting 93 for attachment to the pipe stub is shown to comprise a second fitting part 931 and a set of valve members 932, 933.

The pipe section 91 and the connector fitting 92 is shown in more detail in FIG. 11. As may be seen, the pipe section 91 has an angled cut-off at the end serving as the end 94 forming the actual outlet as described above with reference to FIG. 8.

The insertion depth of the pipe section 91 in the adaptor 70 or in a material inlet pipe may be adjusted by adjusting the position of the connector fitting 92 on the pipe section 91.

The following examples illustrate some possible, non-limiting combinations:
(A1) A method for 3D printing a construction using a printing unit comprising a hopper and a printing head, said printing head being arranged below the hopper in the use state of the printing unit and configured to extrude a printing material via a nozzle opening, the method comprising: obtaining a precursor printing material, the precursor printing material comprising a binder, water, and sand; forming a flow of the precursor printing material towards the printing unit using a material pump; adding downstream of the material pump an amount of a first additive to the precursor printing material; optionally adding one or more additional additives; mixing the precursor printing material, the first additive and the optional one or more additional additives to form the printing material; and extruding the printing material via the printing head. The first additive is added to the precursor printing material before the precursor printing material reaches the hopper.
(A2) A method as denoted in (A1), wherein at least a part of the mixing is done using a rotary element.
(A3) A method as denoted in (A1) or (A2), wherein a rotary element is used for advancing the printing material and generating a continuous flow of printing mate-rial through the printing head during printing.
(A4) A method as denoted in one or more of (A1)-(A3), wherein at least a part of the mixing of the precursor printing material, the first additive and the optional one or more additional additives is done in the hopper.
(A5) A method as denoted in one or more of (A1)-(A4), wherein the optional one or more additional additives is/are added to the precursor printing material in the printing unit.
(A6) A method as denoted in one or more of (A1)-(A5), wherein the first additive and/or the optional one or more additional additives is/are added to the precursor printing material using one or more additive pumps.
(A7) A method as denoted in (A6), wherein the material pump generates a pulsating flow of the precursor printing material towards the hopper, and where the additive pump generates a pulsating flow of the first additive synchronized with the pulsating flow of the precursor printing material.
(A8) A method as denoted in (A6) or (A7), wherein the material pump and the additive pump is synchronized so that the ratio between the volumetric flow of these pumps at any given point in time is substantially constant.
(A9) A method as denoted in one or more of (A1)-(A8), wherein the first additive is a viscosity modifying agents (VMA) configured to increase the viscosity of the precursor printing material.
(A10) A method as denoted in one or more of (A1)-(A9), wherein the volume permille of the first additive in the printing material is at least 0.2%, at least 0.5% or at least 1.2%.
(A11) A method ac as denoted in one or more of (A1)-(A10), wherein the volume permille of the first additive in the printing material is less than 10%, less than 5% or less than 2.5%.
(A12) A method as denoted in one or more of (A1)-(A11), wherein the construction is constructed at a construction site, and where binder, water, and sand is mixed away from the construction side to form the precursor printing mate-rial and by one or more transport vehicles transported to the construction site.
(A13) A method as denoted in one or more of (A1)-(A12), wherein the binder is cement.
(A14) A method as denoted in one or more of (A1)-(A13), wherein the construction is a foundation for a building, a base for a wind turbine, or comprises walls of a building.
(A15) A 3D construction printing system configured for printing using a printing material, the 3D construction printing system comprising a printing unit, a gantry system, a material pump, a flexible tube and an additive system, the printing unit comprising a hopper, a printing head, and a rotary element, and the additive system comprising a control mechanism, an additive outlet, and a control unit, wherein: the gantry system is configured for moving the printing unit in a three-dimensional space; the material pump is configured to receive a precursor printing material comprising binder, water, and sand and pump the precursor printing material towards the printing unit via the flexible tube forming a flow of the precursor printing material in a material transport direction; the hopper is arranged downstream of the material pump in the material transport direction and upstream of the printing head; the control unit is operationally connected to the control mechanism of the additive system for controlling an amount of additive added to the pre-cursor printing material; and the additive outlet of the additive system is located upstream of the hopper in the material transport direction and provides a connection for fluid between the control mechanism and the flow of the precursor printing material downstream of the material pump, the control unit is configured to control the control mechanism to form a flow of the first additive to the flow of precursor printing material, whereby a flow of printing material is formed for extruding via a nozzle opening of the printing head.
(A16) A 3D construction printing system as denoted in (A15), wherein the additive system is configured to add the first additive to the precursor printing material before the precursor printing material reaches the hopper.
(A17) A 3D construction printing system as denoted in (A15) or (A16) wherein the system is configured to at least partly mix the precursor printing material and the first additive in the hopper.
(A18) A 3D construction printing system as denoted in one or more of (A15)-(A17), wherein the control mechanism of the additive system is a control valve and/or an additive pump.
(A19) A 3D construction printing system as denoted in (A18), wherein the material pump is configured to generate a pulsating flow of the precursor printing material towards the hopper, and wherein the additive pump is configured to generate a pulsating flow of the first additive synchronized with the pulsating flow of the precursor printing material.
(A20) A 3D construction printing system as denoted in one or more of (A15)-(A19), wherein an additive outlet is arranged in the printing unit.
(A21) A 3D construction printing system as denoted in one or more of (A15)-(A20), wherein the first additive is a viscosity modifying agents (VMA) configured to increase the viscosity of the precursor printing material.
(A22) A 3D construction printing system as denoted in one or more of (A15)-(A21), further comprising an additive container, the additive container comprising an outlet fluidly connected to the control mechanism of the additive system, wherein the additive container contains an amount of the first additive.
(A23) A 3D construction printing system as denoted in (A22), wherein the additive container is a replaceable container, possibly a single use disposable container.
(A24) A 3D construction printing system as denoted in one or more of (A15)-(A23), wherein the control unit of the additive system is configured to control the control mechanism to add an amount of additive to the flow of precursor printing material so that the volume permille of the first additive in the printing material is at least 0.2%, at least 0.5% or at least 1.2%.
(A25) A 3D construction printing system as denoted in one or more of (A15)-(A23), wherein the control unit of the additive system is configured to control the control mechanism to add an amount of additive to the flow of precursor printing material so that the volume permille of the first additive in the printing material is less than 10%, less than 5% or less than 2.5%.
(A26) A 3D construction printing system as denoted in one or more of (A15)-(A25), wherein the printing unit includes a rotary element configured to advance the printing material and generating a continuous flow of printing material towards the nozzle opening.
(A27) A 3D construction printing system as denoted in one or more of (A15)-(A26), wherein the material pump is a piston pump.
(A28) A 3D construction printing system as denoted in one or more of (A15)-(A27), wherein the hopper is provided with a rotary element comprising a motor and mixing arms.
(A29) A 3D construction printing system as denoted in one or more of (A15)-(A28), wherein the additive system comprises an adaptor arranged between the material pump and the hopper in continuation of the flexible tube so that the flow of the precursor printing material passes through the adaptor, and wherein at least one additive outlet is provided in the adaptor.
(A30) A 3D construction printing system as denoted in (A29), wherein at least one additive outlet is provided on a side of the adaptor, which side will be oriented upwards in the use state.
(A31) A 3D construction printing system as denoted in (A29) or (A30), wherein the adaptor comprises one or more side branches configured for connection to an additive storage unit or for receiving an additive tube with an additive outlet.
(A32) A 3D construction printing system as denoted in (A31), wherein at least one additive tube with an additive outlet extends into the adaptor so that the additive outlet is located at a centre line of the adaptor, said centre line extending in parallel with the material transport direction.
(A33) A 3D construction printing system as denoted in one or more of (A29)-(A32), wherein the additive storage is arranged above the additive outlet in the use state, and wherein a valve or an additive pump is provided to control an amount of additive added.
(A34) A 3D construction printing system as denoted in one or more of (A29)-(A33), further comprising a material inlet valve located upstream of an additive out-let in the material transport direction.
(A35) A printing unit for use in a 3D construction printing system as denoted in one or more of (A15)-(A34) and configured for printing using a printing material comprising a precursor printing material and a first additive, the precursor printing material comprising a binder, water, and sand, said printing unit comprising: a material inlet; a hopper configured for accommodating a quantity of the printing material; a printing head configured for extruding the printing material, said printing head being arranged downstream of the hopper in a material transport direction; a rotary element configured for moving the printing material in the material transport direction from the hopper to the printing head; and an additive outlet, wherein the additive outlet is located upstream of the hopper in the material transport direction.
(A36) A printing unit as denoted in (A35), further comprising a rotary element arranged in the hopper.
(A37) A printing unit as denoted in (A35) or (A36), wherein the material inlet comprises an inlet pipe projecting from a main body of the hopper, and where one or more additive outlet(s) is/are provided in the material inlet pipe.
(A38) A printing unit as denoted in (A37), wherein at least one additive outlet is provided on a side of the material inlet pipe, which side will be oriented upwards in the use state of the printing unit.
(A39) A printing unit as denoted in (A37) or (A38), wherein at least one additive outlet is formed in an additive tube, the additive tube projecting into the material inlet pipe.
(A40) A printing unit as denoted in one or more of (A37)-(A39), wherein at least one additive outlet is located at a centre line of the material inlet pipe, said centre line extending in parallel with the material transport direction.
(A41) A printing unit as denoted in one or more of (A37)-(A40), wherein at least a distal section of an additive tube having an additive outlet extends substantially in parallel to the centre line of the material inlet pipe, said centre line extending in parallel with the material transport direction.
(A42) A printing unit as denoted in one or more of (A35)-(A41), further comprising an additive storage unit connected to an additive outlet.
(A43) A printing unit as denoted in (A42), wherein the additive storage is arranged above the additive outlet in the use state of the printing unit, and where a valve or an additive pump is provided to control an amount of additive added.
(A44) A printing unit as denoted in one or more of (A35)-(A43), further comprising a material inlet valve located upstream of an additive outlet in the material transport direction.

The embodiments shown on the drawing and described above are only intended as examples and are in no way intended to be limited the scope of the invention, which is defined by the appended claims.

1. A method for 3D printing a construction using a printing unit comprising a hopper and a printing head, said printing head being arranged below the hopper in the use state of the printing unit and configured to extrude a printing material via a nozzle opening, the method comprising:
obtaining a precursor printing material, the precursor printing material comprising a binder, water, and sand;
forming a flow of the precursor printing material towards the printing unit using a material pump;
adding downstream of the material pump an amount of a first additive to the precursor printing material;
mixing the precursor printing material and the first additive to form the printing material; and
extruding the printing material via the printing head
wherein the first additive is added to the precursor printing material before the precursor printing material reaches the hopper.

2. The method according to claim 1, wherein at least a part of the mixing is done using a rotary element.

3. The method according to claim 1, wherein a rotary element is used for advancing the printing material and generating a continuous flow of printing material through the printing head during printing.

4. The method according to claim 1, wherein at least a part of the mixing of the precursor printing material and the first is done in the hopper.

5. The method according to claim 1, further comprising adding one or more additional materials, wherein the one or more additional additives is/are added to the precursor printing material in the printing unit.

6. The method according to claim 1, wherein the first additive is added to the precursor printing material using one or more additive pumps.

7. The method according to claim 6, wherein the material pump generates a pulsating flow of the precursor printing material towards the hopper, and where the additive pump generates a pulsating flow of the first additive synchronized with the pulsating flow of the precursor printing material.

8. The method according to claim 6, wherein the material pump and the additive pump is synchronized so that the ratio between the volumetric flow of these pumps at any given point in time is substantially constant.

9. The method according to claim 1, wherein the first additive is a viscosity modifying agent (VMA) configured to increase the viscosity of the precursor printing material.

10. The method according to claim 1, wherein the volume permille of the first additive in the printing material is at least 0.2.

11. The method according to claim 10, wherein the volume permille of the first additive in the printing material is less than 10%.

12. The method according to claim 1, wherein the construction is constructed at a construction site, and wherein the binder, water, and sand is mixed away from the construction site to form the precursor printing material and by one or more transport vehicles transported to the construction site.

13. The method according to claim 1, wherein the binder is cement.

14. The method according to claim 1, wherein the construction is a foundation for a building, a base for a wind turbine, or comprises walls of a building.

15. A 3D construction printing system configured for printing using a printing material, the 3D construction printing system comprising:
a printing unit, comprising:
a hopper;
a printing head; and
a rotary element;
a gantry system;
a material pump;
a flexible tube; and
an additive system, comprising:
a control mechanism;
an additive outlet; and
a control unit;
wherein:
the gantry system is configured for moving the printing unit in a three-dimensional space;
the material pump is configured to receive a precursor printing material comprising binder, water, and sand and pump the precursor printing material towards the printing unit via the flexible tube forming a flow of the precursor printing material in a material transport direction;
the hopper is arranged downstream of the material pump in the material transport direction and upstream of the printing head;
the control unit is operationally connected to the control mechanism of the additive system for controlling an amount of additive added to the precursor printing material; and
the additive outlet of the additive system is located upstream of the hopper in the material transport direction and provides a connection for fluid between the control mechanism and the flow of the precursor printing material downstream of the material pump, and the control unit is configured to control the control mechanism to form a flow of the first additive to the flow of precursor printing material, whereby a flow of printing material is formed for extruding via a nozzle opening of the printing head.

16. The 3D construction printing system according to claim 15, wherein the additive system is configured to add the first additive to the precursor printing material before the precursor printing material reaches the hopper.

17. The 3D construction printing system according to claim 15, wherein the system is configured to at least partly mix the precursor printing material and the first additive in the hopper.

18. The 3D construction printing system according to claim 15, wherein the control mechanism of the additive system is a control valve and/or an additive pump.

19. The 3D construction printing system according to claim 18, wherein the material pump is configured to generate a pulsating flow of the precursor printing material towards the hopper, and wherein the additive pump is configured to generate a pulsating flow of the first additive synchronized with the pulsating flow of the precursor printing material.

20.-34. (canceled)

35. A printing unit for use in a 3D construction printing system wherein the printing system is configured for printing using a printing material comprising a precursor printing material and a first additive, the precursor printing material comprising a binder, water, and sand, said printing unit comprising:
a material inlet;
a hopper configured for accommodating a quantity of the printing material;
a printing head configured for extruding the printing material, said printing head being arranged downstream of the hopper in a material transport direction;
a rotary element configured for moving the printing material in the material transport direction from the hopper to the printing head; and
an additive outlet, wherein the additive outlet is located upstream of the hopper in the material transport direction.

36.-44. (canceled)
